(19) United States
(12) Patent Application Publication
(10) Pub. No.: US 2020/0134612 A1
(43) Pub. Date: Apr. 30, 2020

(54) BLOCKCHAIN BASED MESSAGING SYSTEM AND METHOD

(71) Applicant: Advanced Planet Co. LTD, Taipei City (TW)

(72) Inventors: Dmitry Fostiropulo, Moscow (RU); Alexander Kuntsman, Moscow (RU)

(73) Assignee: Advanced Planet Co. LTD, Taipei City (TW)

(21) Appl. No.: 16/670,056

(22) Filed: Oct. 31, 2019

Related U.S. Application Data
(60) Provisional application No. 62/753,085, filed on Oct. 31, 2018.

(51) Int. Cl. G06Q 20/38; H04L 29/06; G06Q 30/02

(52) U.S. Cl. CPC G06Q 20/389; G06Q 30/0242; G06Q 30/0214; H04L 63/18

(57) ABSTRACT

A communication channel enabling method includes establishing a first communication channel between a first computing system and a second computing system within a computer network. Electronic content is associated with a token generated using a blockchain. The electronic content and the token are transmitted from the first computing system to the second computing system, and a first record is created on the blockchain. The electronic content and the token are transmitted to a third computing system and a second record is created on the blockchain responsive to an instruction generated via the second computing system. A second communication channel is established between the first computing system and the third computing system, and a third record is created on the blockchain.

### CROSS REFERENCE TO RELATED APPLICATION(S)

This application claims the benefit of U.S. Provisional Application No. 62/753,085, filed Oct. 31, 2018 which is incorporated by reference as if fully set forth.

### FIELD OF INVENTION

This invention relates generally to user data security, and more particularly to blockchain based messaging security and user behavior analytics and consensus.

### BACKGROUND

Businesses typically employ some manner of software-enabled contact relationship management (“CRM”) system including contact details for customers and potential customers. There is often a great deal of value associated with these contact details, such value associated with the cost of acquiring the contact details and keeping the contact details current and up to date. Businesses are likely to have contractual or other legal obligations to maintain the security of acquired contact details and to not purposely or inadvertently disclose the contact details. Accordingly a business' ability to fully utilize or monetize through digital means the data of customers and potential customers is necessarily limited.

Many businesses seek engagement with consumers through digital means, relying on various platforms for the delivery of electronic content, tracking user behavior, and generating consumer behavior analytics. Businesses are demanding more transparency regarding consumer behavior analytics and proof of electronic user engagement that the businesses pay for, for example engagement obtained via “pay-per-click” advertising. Large platforms, such as Facebook™ and Google™, gather huge amounts of data to provide participating businesses with socio-demographic and consumer behavior analytics, enabling participating businesses to target particular consumer groups that they are interested in engaging with. However, socio-demographic and consumer behavior analytics currently used by businesses to target their consumer contacts may be poorly supported by facts and data and are often exaggerated. Businesses may not trust the analytics available or they may consider the analytics to be in some manner exaggerated.

Computing device users are frequently inundated with communications from electronic content providers via applications specially produced by or for the content providers and downloaded to and executed on the users' computing devices (e.g., smart phones, tablets, and personal computers). Management of the delivery of this electronic content, for example offers, advertisements, and challenges, can be daunting for the computing device users.

Governments require more controls and restrictions regarding privacy of user data used by businesses for analytics and targeting. Recent General Data Protection Regulation restrictions and updates in the European Union, as well as initiatives by the United States and Asian authorities demand more controls and restrictions over user data.

### SUMMARY

This Summary introduces simplified concepts that are further described below in the Detailed Description of Illustrative Embodiments. This Summary is not intended to identify key features or essential features of the claimed subject matter and is not intended to be used to limit the scope of the claimed subject matter.

A communication channel enabling method is provided including establishing a first communication channel between a first computing system and a second computing system within a computer network. Electronic content is associated with a token generated using a blockchain. The electronic content and the token are transmitted from the first computing system to the second computing system, and a first record is created on the blockchain corresponding to the transmitting of the electronic content and the token from the first computing system to the second computing system. The electronic content and the token are transmitted to a third computing system, and a second record is created on the blockchain corresponding to the transmitting of the electronic content and the token to the third computing system responsive to an instruction generated via the second computing system. A second communication channel is established between the first computing system and the third computing system, and a third record is created on the blockchain responsive to a user action via the third computing system.

An electronic content delivering method is provided including receiving an indication of a targeted group of users to whom electronic content is to be delivered from a first entity. A cost of delivering the electronic content to the group of users is determined based on a contract encoded on a blockchain. A credit balance of an electronic contract account of the first entity is determined by query to the blockchain. The electronic contract account of the first entity is debited via the blockchain based on the cost of delivering the electronic content to the group of users.

A further electronic content delivering method is provided including receiving contact information of a user from a first entity. Selectable entity indications are transmitted to the user via a computing device based on the contact information. A first digital currency value is transferred from the first entity to the user via the computing device and the transfer of value is recorded on a blockchain. A selection of a second entity is received from the user via the computing device via the selectable entity indications to initiate a subscription to the second entity. A transmission of electronic content from the second entity to the user is enabled, and the transmission of the electronic content from the second entity to the user is recorded on the blockchain. A second digital currency value from the second entity to the first entity is transferred responsive at least to the receiving from the user the selection of the second entity, and recording on the blockchain the transferring of the second digital currency value from the second entity to the first entity.

Further provided is an ecosystem where actions and events are tracked and records recorded on a blockchain to provide indisputable data. Participants of the ecosystem can use these records to prove or disprove potential queries or accusations, from a government or other body claiming or acting against them.

### BRIEF DESCRIPTION OF THE DRAWING(S)

A more detailed understanding may be had from the following description, given by way of example with the accompanying drawings. The Figures in the drawings and the detailed description are examples. The Figures and the detailed description are not to be considered limiting and other examples are possible. Like reference numerals in the Figures indicate like elements wherein:

FIG. 1 is a diagram figuratively showing blockchain communication channels according to an illustrative embodiment.

FIG. 2 shows a network environment illustrating the architecture of an illustrative embodiment for enabling blockchain communication channels.

FIG. 3 is a diagram showing two-way communication flows between electronic content providing entities and end users.

FIGS. 4A and 4B are flowcharts showing methods of establishing communication channels and receiving electronic content.

FIG. 5 is a diagram figuratively showing a blockchain-enabled data sharing process.

FIG. 6 is a diagram showing an exemplary process data flow enabled by the architecture of FIG. 2.

FIG. 7 is a flowchart showing a method of establishing communication channels for network-connectable computing systems.

FIGS. 8 and 9 are flowcharts showing electronic content delivering methods.

### DETAILED DESCRIPTION OF ILLUSTRATIVE EMBODIMENT(S)

The herein disclosed embodiments enable a reducing of communication channels to network-connectable computing devices, particularly communication channels delivering streams of electronic content in the form of advertisements, offers, and applications to computing devices from network-connected servers. In a particular implementation, two-way direct communication channels are set up between a first computing system, for example a system operated by a business entity (e.g., a “vendor”, and a second computing system, for example a system operated by a consumer (e.g., an “end user”). Business entities including brand owners (hereinafter “brands”), manufacturers, and vendors determine consumer preferences through an application-enabled vendor selection and profile set up process on their respective computing systems. A management system manages, secures, and stores consumer personal data and shares the data with selected brands, manufacturers, vendors, or other business entities by the consent of the consumer.

An application executed on a consumer (“end user”) system (hereinafter “consumer application”) enables the consumer to decide with which entity (e.g., brand, manufacturer, or vendor) they want to set up a connection with (e.g., “subscribe to”) and with which level of security they want to keep personal data open to the selected entities. Consumers are also enabled to provide electronic feedback (e.g., text, digital photo, and video) to multiple selected entities through a single interface enabled by the application, thereby circumventing the need to connect to multiple disparate computer network locations and application program interfaces enabled by brands, manufacturers, vendors, or other entities to deliver electronic feedback.

The system described herein enables an entity, for example a business entity including a brand, manufacturer, or vendor, which entity maintains an existing customer relationship management (“CRM”) database to build a link to customers of other entities which maintain other CRM databases. This allows entities, for example brands, manufacturers, and vendors to target their offers to a group of consumers (e.g., “end users”) by identification of consumers via a blockchain-connected application linked to a CRM database.

The system described herein further allows creating and using a token-based digital asset model and controlling the process of creating a CRM opportunity or CRM offer, a process traditionally implemented in a free form document. A separate CRM channel includes a blockchain channel that allows integration between a traditional CRM (e.g., a sales environment CRM) and a blockchain. The consumer application further allows incorporating peer-to-peer communication functionality from social networks. Each end user of the consumer application can belong to one or more existing CRM databases of one or more entities (e.g., a brand, manufacturer, or vendor) and via a messaging component of the consumer application is able to receive application electronic content (e.g., offers) from user-selected (e.g., “subscribed to”) entities which maintain the respective CRM databases. Further, the end user may select additional entities (e.g., brands, manufacturers, or vendors) listed in an interface enabled by the consumer application and receive electronic content therefrom. Contact data and other data in an entity's CRM database is used as a potential address book of a messenger supported by the system. The system manages several CRM databases at the same time executing operations via a blockchain to provide a requisite level of data security and user privacy.

The system described herein enables a combining of CRM data from multiple entities in one secured computer network environment and an ensuring of zero tolerance between vendors. Implementing a blockchain allows a consensus to be reached between multiple entities in the storing of different CRM databases of different entities in one network environment. A messaging component incorporating social network elements and using a blockchain platform allows a particular end user (e.g., a consumer) to be accessed by a plurality of different business entities (e.g., brands, manufacturers, and vendors) irrespective of whether all or any of the different entities possessed contact details of the particular end user in their CRM database. The particular end user is enabled to select (e.g., flag, follow, sign up with) particular entities, granting those entities the right to transmit electronic content (e.g., information, offers, and rewards) to the particular end user. A particular end user is further enabled via the messaging component to share electronic content of particular entities with other end users to securely and safely extend the CRM databases of the particular entities. Particular entities (e.g., business entities) can access behavior analytics attributed to end users who select (e.g., flag, follow, sign up with) them. End users are enabled to confirm their legal age (e.g., 18 years or older) and consent to system policies or protocols, and the system collects end user's consent and age proof via network communication. The system makes record on a blockchain with pertinent corresponding information including user consent and personal information confirmation, user computing device identification, user computing device location, time of consent or confirmation, whether the end user engaged with the system via web browser or mobile source, and any additional incomplete or complete information mentioned by the user.

The system described herein enables assessment of the efficiency of communication activities (e.g., sales communications). A blockchain implementation enables tokenizing of communications (e.g., tokenized sales, tokenized offers) to reduce computer bandwidth requirements and increase communication efficiency, thereby reducing communication costs. Marketing costs of campaigns are reduced, especially in mass-market segments, at least due to the exclusion of intermediaries (e.g., retailers, agents). Since tokens are trackable, more accurate communication data (e.g., sales data) can be collected. Since activities are tracked in a blockchain, results of communications (e.g., results of a sales campaign) cannot be falsified since an already generated and transmitted token cannot be modified. Accordingly, a direct communication channel (e.g., manufacturer or vendor to consumer sales/communication channel) is enabled by integrating a blockchain protocol.

The system as described herein establishes a platform that enables transparency and consensus in complex relationships of users of the platform by making records of key events on a blockchain. Event traceability capabilities of the system are attributed in part to the ability of the system to have direct contact with the electronic activities of a user.

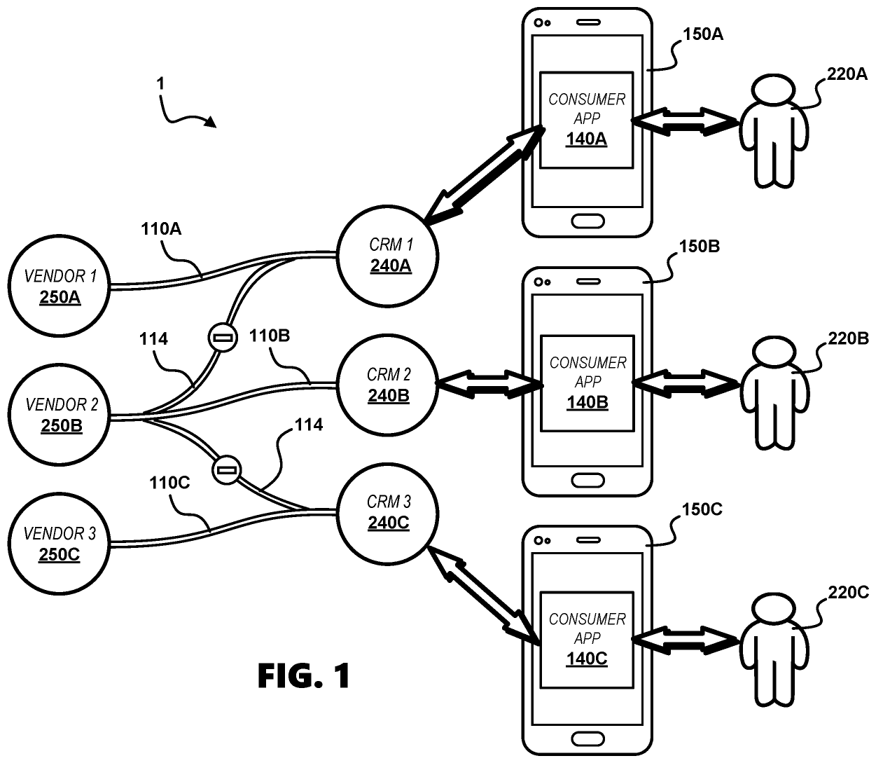

Referring to FIG. 1 a communication environment 1 includes blockchain-supported communication channels 110A, 110B, 110C between vendor systems 250A, 250B, 250C and end users 220, which communication channels 110A, 110B, 110C are enabled by contact relationship management (“CRM”) databases 240A, 240B, 240C and consumer applications 140A, 140B, 140C executed by computing devices 150A, 150B, 150C. The computing devices 150A, 150B, 150C can each include for example a smart phone or other cellular-enabled mobile communication device operable in wireless telecommunications network. Alternatively, the computing devices 150A, 150B, 150C can each include a personal computer, tablet device, video game console, digital media player or other computing device operable in a wired or wireless computer network, for example including the Internet.

The CRM databases 240A, 240B, 240C function as contact lists for messaging components of the respective consumer applications 140A, 140B, 140C. For example, a messaging component of a first consumer application 140A establishes a first communication channel 110A with a first vendor system 250A, wherein contact data from a first CRM database 240A establishes an electronic address book for contacting consumers including a first end user 220A. A messaging component of a second consumer application 140B establishes a second communication channel 110B with a second vendor system 250B wherein contact data from a second CRM database 240B establishes an electronic address book for contacting consumers including a second end user 220B. A messaging component of a third consumer application 140C establishes a third communication channel 110C with a third vendor system 250C wherein contact data from a third CRM database 240C establishes an electronic address book for contacting consumers including a third end user 220C. By operation in a blockchain environment, the respective messaging components of the consumer applications 140A, 140B, 140C are precluded from accessing other communication channels for example via blocked paths 114.

End users 220A, 220B, 220C can share with each other electronic content (e.g., offers) received via their respective communication channels 110A, 110B, 110C with other end users 220A, 220B, 220C who can then subscribe to the communication channels 110A, 110B, 110C of the shared electronic content. For example, if the first end user 220A via a messaging component of the first consumer application 140A actively communicates with the first vendor system 250A through the first communication channel 110A, the first end user 220A can transmit the electronic offer to the second and third end users 220B, 220C via the messaging component of the first consumer application 140A. The second and third end users 220B, 220C can accept the electronic offer and subscribe to the first communication channel 110A to permit communication with the first vendor system 250A. Alternatively, the consumer applications 140A, 140B, 140C can generate suggestions to the end users 220A, 220B, 220C of communication channels 110A, 110B, 110C to which they are not already to subscribed and allow them to subscribe thereto. For example the end user 220A, initially subscribed to the communication channel 110A by virtue of having contact information listed in the first CRM database 240A, can subscribe to communication channel 110E without initially having their contact information listed in the second CRM database 240B.

Permitting end users 220A, 220B, 220C to subscribe to multiple communication channels 110A, 110B, 110C allows vendor systems 250A, 250B, 250C to extend their respective CRM databases 240A, 240B, 240C. An end user 220A, 220B, 220C which subscribes to a communication channel 110A, 110B, 110C voluntarily, provides contact information to the respective vendor system 250A, 250B, 250C operating the particular communication channel 110A, 110B, 110C.

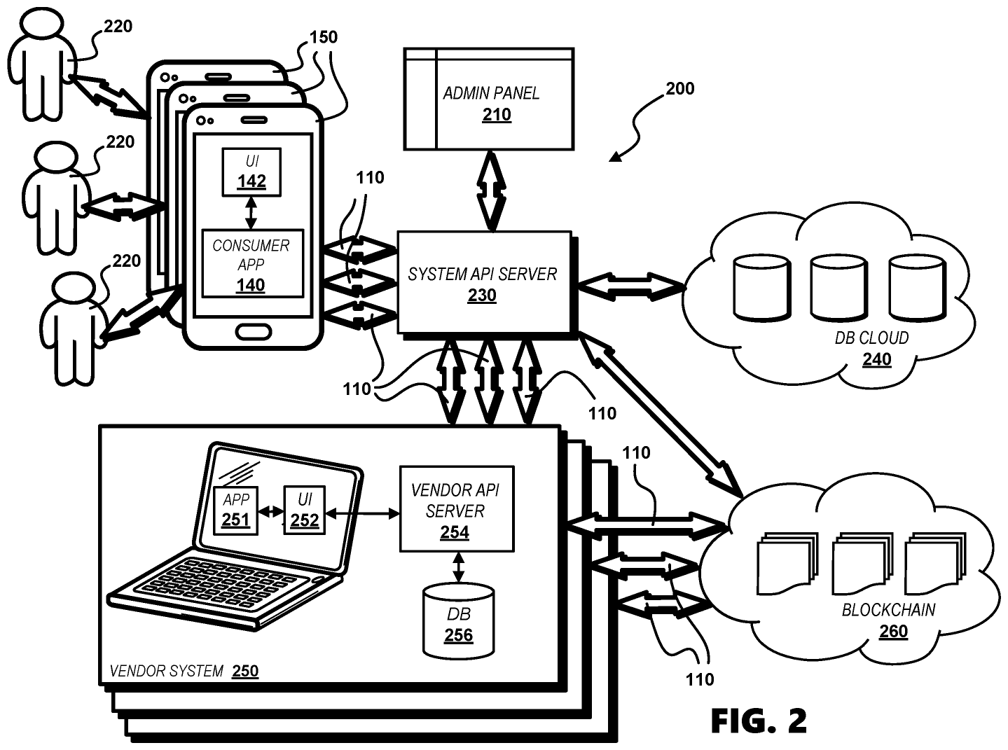

Referring to FIG. 2, principal architecture 200 of an illustrative embodiment for enabling blockchain communication channels is shown in a computer network environment. End users 220 communicate via the consumer application 140 executed on their respective computing devices 150 via a system application program interface (“API”) server 230. The consumer application 140 is representative of each of the consumer applications 140A, 140B, 140C described herein. The system API server 230 is configured to process end user 220 and vendor activities including communication via communication channels 110 enabled by the vendor system 250 which is representative of each of the vendor systems 250A, 250B, 250C, 250D, 250E described herein. Depending on the type of request, the system API server 230 communicates to a database (“DB”) cloud 240 for storing and retrieving public information, to a blockchain 260 beneficially operating in a peer-to-peer network environment for storing and retrieving private or sensitive information such as value transactions, and to a vendor system 250 for receiving offers from vendor users (e.g., business entities) via a vendor user interface 252 and informing vendor users regarding end user subscriber preferences via the vendor user interface 252. The functionality of the vendor system 250 is beneficially enabled by a software vendor application 251 executed by one or more processors. The vendor system 250 can include one or more network connected computing systems, for example a plurality of computing devices operating in a peer-to-peer configuration.

The vendor system 250 transmits electronic content (e.g., offers) to a targeted group of end users 220 (e.g., consumers) via the vendor API server 254 using a blockchain-supported communication channel 110. Electronic content is created in token format using the blockchain 260. Every token tracks from creation to release such that each action and transaction is validated, for example for the purpose of accurately tracking the efficiency and return on investment of a sales campaign initiated via the vendor system 250. The blockchain 260 enables this validation by storing information about asset owners (e.g., vendors and consumers) and enabling retrieval of true statistical information about transactions.

The vendor application 251 enables the creation of a business profile including an account to power connections with end users 220 (e.g., consumers). A business profile can be created by business entities including for example brands, vendors, manufacturers, retailers, and influencers to power the connections with the end users 220. Business entities and end users 220 are together the participants in the described architecture 200. A brand includes for example a manufacturer or trademark owner who seeks engagement with an end user 220. A retailer includes for example a mono-brand retailer, grocery retailer, specialized retailer, supermarket retailer, shopping mall owner, or shopping center owner that accommodates or sells various categories of goods or services for example categorized as auto, fashion, food and drink, luxury, health and beauty, cosmetics, restaurants, fast food, entertainment, and travel. An influencer includes for example an opinion leader, celebrity, or well-known public persona who may impact public opinion regarding certain topics of interest. The principal architecture 200 through the system API server 230 and consumer application 140 enables an end user 220 to connect directly with brands, manufacturers, influencers, and retailers to enjoy electronic content including for example music, video, challenges, polls, and time relevant discounts which are for example specific to a geographic location of the end user 220. Transactions within the principal architecture 200 are enabled by cryptographic currency, beneficially a stablecoin cryptographic currency, a cryptographic currency with a stable value, and more beneficially a stablecoin based on Hyperledger™ fabric permissioned blockchain infrastructures.

Connection by businesses with end users 220 is facilitated by the system API server 230 via the vendor application 251 by allowing businesses to target end users 220. The targeting can include narrowing messaging to certain user audiences divided for example by socio-demographic and behavioral clusters. Socio-demographic clusters can be defined for example by gender, income, demographic characteristics, and user age.

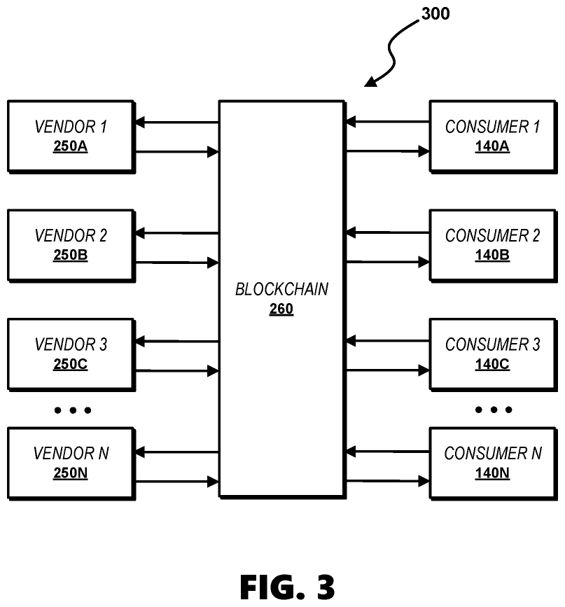

Referring to FIG. 3, communication flow diagram 300 shows communication flows supported by the blockchain 260 between vendor systems 250A, 250B, 250C, 250N and consumer applications 140A, 140B, 140C, 140N. The blockchain 260 supports many possible communication relations including vendor system 250A with consumer application 140A, vendor system 250B with consumer application 140B, and vendor system 250N with consumer application 140N. The blockchain 260 supports two way communication. Referring to FIG. 2, sensitive data is beneficially stored by a vendor system 250 such as vendor systems 250A, 250B, 250C, 250N, for example in database 256 or encrypted on the blockchain 260. Contact relationship management (“CRM”) data (e.g., stored in contact relationship management (“CRM”) databases 240) from different vendor systems 250 can be used in accessing users via consumer applications 140 executed on multiple computing devices 150 without any cross communication affecting an overall security level.

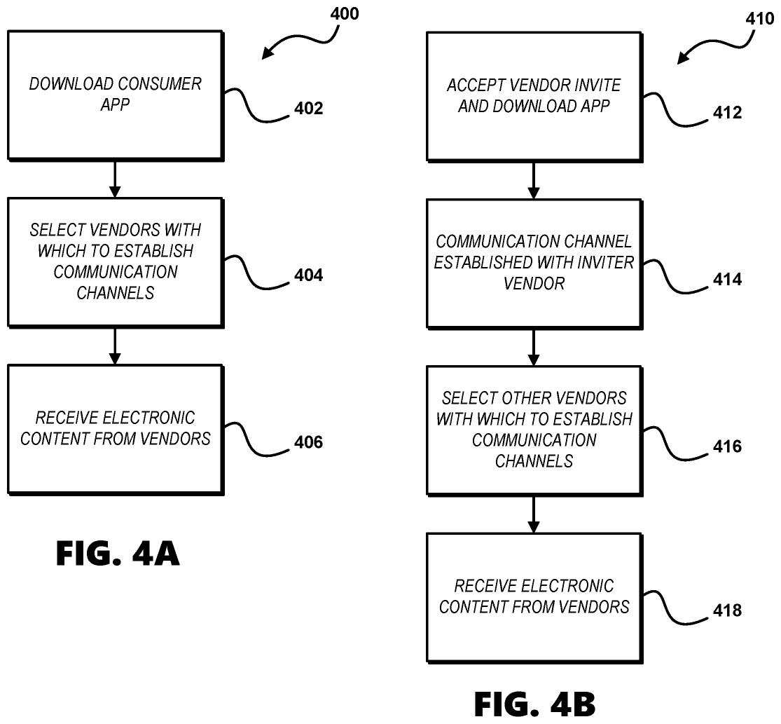

Referring to FIG. 4A, a diagram of a method 400 of establishing communication channels and transmitting electronic content is shown. The method 700 and associated processes are described with reference to the components of the architecture 200 shown in FIG. 2, including the vendor system 250, system API server 230, consumer application 140, blockchain 260, and related components. Alternatively, the method 400 can be performed via other suitable systems.

In a step 402, an end user 220 (e.g., a consumer) downloads a consumer application 140 onto a computing device 150. The end user 220 via the consumer application 140 selects vendors already registered with the system API server 230, which vendors operate respective vendor systems 250 enabled by a vendor application 251, and communication channels 110 are established with selected vendors (step 404). The computing device 150 operated by the end user 220 receives electronic content from the vendor systems 250 via the consumer application 140 and the system API server 230 (step 406). The electronic content can include for example offers and information from vendors in various forms including video, graphic, text, or quick response (“QR”) code. The electronic content beneficially further includes instant rewards-based blockchain based tokens from vendors associated with offers, promotional content, or referral programs.

Referring to FIG. 4B, a diagram of a method 410 of establishing communication channels and transmitting electronic content in a case in which an end user receives an invitation from a vendor system 250 via the system API server 230. The method 410 and associated processes are described with reference to the components of the architecture 200 shown in FIG. 2, including the vendor system 250, system API server 230, consumer application 140, blockchain 260, and related components. Alternatively, the method 410 can be performed via other suitable systems.

In a step 412, an end user 220 (e.g., a consumer) receives and accepts an invitation from the vendor system 250 and downloads a consumer application 140 onto a computing device 150 of the end user 220. A communication channel 110 is established with the inviter vendor (step 414). The end user 220 via the consumer application 140 selects other vendors already registered with the system API server 230, which other vendors operate other respective vendor systems 250 enabled by a vendor application 251, and other communication channels 110 are established with the selected other vendors (step 416). The computing device 150 operated by the end user 220 receives electronic content from the vendor systems 250 via the consumer application 140 and the system API server 230 (step 418). The electronic content can include for example offers and information from vendors in various forms including video, graphic, text, or quick response (“QR”) code. The electronic content beneficially further includes instant rewards-based blockchain based tokens from vendors associated with offers, promotional content, or referral programs.

A consumer user interface 142 is enabled by the consumer application 140. Interactions by an end user 220 are recorded on the blockchain 260. Example user interactions with electronic content via the consumer user interface 142 and non-interactions which can trigger a recording on the blockchain 260 are provided in Table 1 below.

TABLE 1

| Consumer User Interface (“UI”) 142 | Blockchain 260 |
|---|---|
| Delivery of content (e.g., video, music, polls, text, deals, | Record on blockchain created |
| discounts, offers) to user | |
| Rejection of delivered content by deleting without | Record on blockchain created |
| viewing or interacting | |
| No action toward content (e.g., no view or response) | Record on blockchain created |
| within lifetime of content | |
| Viewing of content (e.g., viewing a video to the end) | Record on blockchain created |
| Stopping viewing of content after certain time period | Record on blockchain created |
| (e.g., stopping viewing a video) | |
| Restarting viewing of content (e.g., restarting viewing of | Record on blockchain created |
| a video) | |
| Clicking on link in content to access a network resource | Record on blockchain created |
| (e.g., web site on the Internet) | |
| Opening a QR code or coupon in content | Record on blockchain created |
| Transferring and delivering a reward (e.g., to another | Record on blockchain created |
| user) | |
| Redeeming a discount, coupon, or reward | Record on blockchain created |

Every message related to delivery of content from a business entity (e.g., brand, manufacturer, retailer, or influencers) via a vendor system 250 to an end user 220 (e.g., consumer) via a consumer application 140 executed on a computing device 150 has a cost to be paid by the business entity, which cost is governed by a blockchain-enabled smart contract. The cost is beneficially set via an administration panel 210 in communication with the system API server 230. Referring to Table 2 below, the transactions and actions occurring via the vendor user interface 252 enabled by the vendor application 251 with access to a particular business' profile are shown on the left column, and the transactions and actions enabled via the blockchain 260 are shown on the right column.

TABLE 2

| | Vendor User Interface (“UI”) | | |
|---|---|---|---|
| Step | 252 | Step | Blockchain 260 |
| 504 | The business evaluates a target | 502 | The system API server 230 refers |
| | group of end users 220 to whom | | to a price per message set in a |
| | it intends to deliver content, the | | smart contract attributed to a |
| | cost of the action per end user | | business enabled by the |
| | 220 or group of end users 220 is | | blockchain 260 to evaluate a cost |
| | displayed in stablecoin in UI 252. | | of action. |
| 504 | The brand evaluates a target | 502 | The system API server 230 refers |
| Example | group of end users 220 to whom | Example | to a price per message set in a |
| | it intends to deliver content and | | smart contract attributed to a |
| | who follow a particular | | particular brand enabled by the |
| | influencer, the cost of the action | | blockchain 260 to evaluate a cost |
| | is displayed in stablecoin in UI | | of action. |
| | 252 | | |
| 508 | The business prepares to initiate | 506 | The system API server 230 |
| | content delivery to the target | | requests information from the |
| | group of end users 220 at a | | blockchain 260 on the balance in |
| | validated price; a current balance | | stablecoin on the smart contract |
| | in stablecoin on the smart | | attributed to the business and |
| | contract and expected cost of | | matches it with evaluated cost |
| | action is displayed in UI 252. | | (“validated price”) of the action. |
| 508 | The particular brand prepares to | 506 | The system API server 230 |
| Example | initiate content delivery at the | Example | requests information from the |
| | validated price to the target | | smart contract on the balance in |
| | group of end users 220 who | | stablecoin attributed to the |
| | follow the particular influencer; a | | particular brand, the commission |
| | current balance in stablecoin on | | level in stablecoin attributed to |
| | the smart contract is displayed; | | the particular influencer, and the |
| | the cost of the action is broken | | overall cost (“validated price”) |
| | down by commission amount of | | of the action; wherein |
| | the particular influencer and the | | commission level is defined by |
| | service cost for operating the | | agreement between the |
| | system API server 230. | | influencer and the administrator |
| | | | of the system API server 230 and |
| | | | set in percent in smart contract. |
| 510 | The business requests top up of | 512 | The business' wallet account is |
| | their stablecoin balance of the | | debited and a smart contract |
| | smart contract via UI 252. | | account attributed to the |
| | | | business is credited a |
| | | | corresponding amount via the |
| | | | blockchain 260. |
| 514 | The business initiates content | 516 | The smart contract account |
| | delivery to the target group of | | attributed to the business is |
| | end users 220 via the UI 252. | | debited, and a wallet of an |
| | | | administrator of the system API |
| | | | server 230 is credited a |
| | | | corresponding amount. |

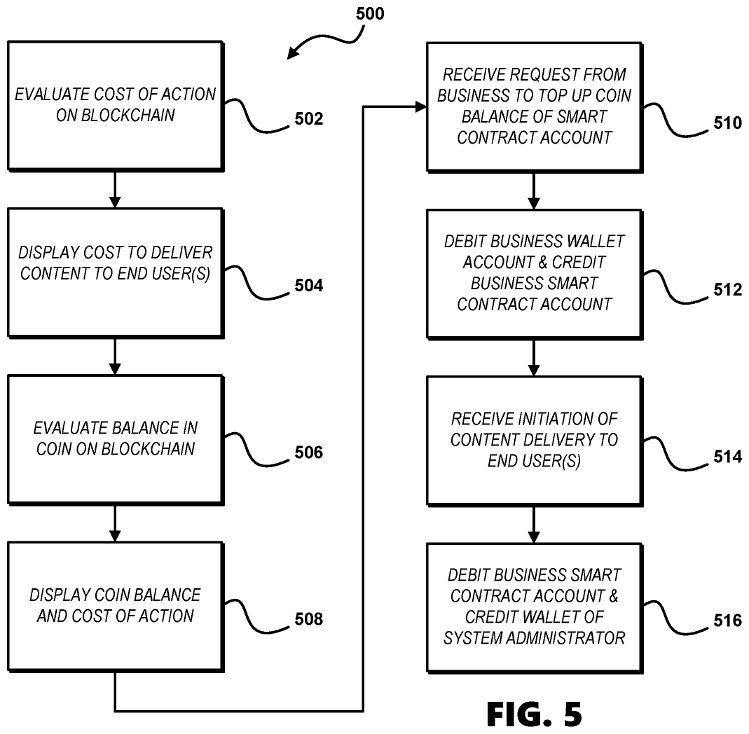

Referring to FIG. 5, the steps set forth in Table 2 are described from the perspective of the system API server 230 as a method 500. In the step 502. the system API server 230 refers to a price per message set in a smart contract attributed to a business entity and enabled by the blockchain 260 to evaluate a cost of an action. The cost of the action per end user 220 or group of end users 220 is displayed in stablecoin in UI 252 via the vendor application 251 based on data provided by the system API server 230 (step 504). The system API server 230 requests information from the blockchain 260 on the balance in stablecoin on the smart contract attributed to the business entity and matches it with the evaluated cost of the action (step 506). A current balance in stablecoin on the smart contract and evaluated cost of the action is displayed in UI 252 via the vendor application 251 (step 508). The system API server 230 receives a request from a business entity (e.g., a business user) via the UI 252 and via the vendor application 251 to top up (i.e., add value to) the stablecoin balance of the smart contract (step 510). In response, the system API server 230 debits a wallet account of the business entity and credits a smart contract account attributed to the business entity via the blockchain 260 by a corresponding amount (step 512). The system API server 230 receives a request to initiate content delivery to the target group of end users 220 through the vendor UI 252 via the vendor application 251 (step 514). Responsive to the request, the system API server 230 debits the smart contract account attributed to the business entity and credits a wallet of an administrator of the system API server 230 a corresponding amount (step 516).

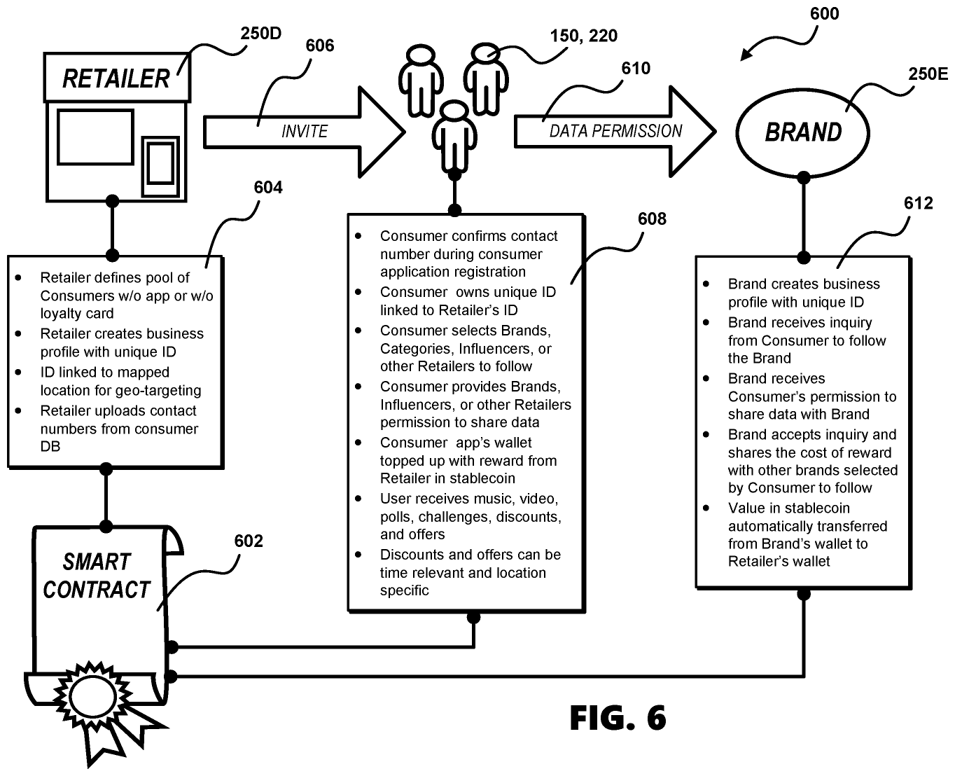

The system API server 230 enables a user acquisition process in which a particular business entity incurs the initial cost per acquisition (“CPA”) for connection with a particular end user 220 (e.g., customer), and other entities compensate the particular business entity for the CPA, for example proportionally or by agreed terms. A smart contract enabled by the blockchain 260 controls the execution of the user acquisition process. Referring to FIG. 6, an exemplary process data flow 600 is shown enabled by the architecture 200 including the system API server 230, the consumer application 140, the vendor application 251, and corresponding components as described with reference to FIG. 2. In the exemplary process data flow 600, a retailer vendor system 250D (operated by a retailer) through a vendor user interface 252 and a vendor application 251 performs retailer actions 604 tracked via a smart contract 602 enabled by the blockchain 260. The retailer actions 604 include defining a pool of consumers, beneficially consumers who are not yet users of the consumer application 140 or do not have a loyalty card or related membership privileges with the retailer, creating a business profile with a unique ID, initiating a link to a mapped location (e.g., retail store location) for geo-targeting, and uploading contact details (e.g., phone numbers) from the retailer's customer database.

In an invite action 606, the retailer vendor system 250D transmits to end users 220 (i.e., “consumers”) an invitation to download the consumer application 140 from the retailer's customer database, for example via Short Message Service or email protocol to computing devices 150 of the end users 220. The invitation beneficially includes a user-redeemable reward or a voucher. End user actions 608 include actions by an end user 220 recordable through the smart contract 602 via the blockchain 260. An end user 220 (i.e., “consumer”) can confirm contact details via a computing device 142 during registration with the system API server 230 via the consumer application 140, and the end user 220 is assigned a unique identifier (“ID”) linked to an ID of the retailer vendor system 250D. The end user 220 is enabled to select brands, influencers, other retailers, or other types of business entities or categories of businesses entities to follow via the consumer application 140. The end user 220 is further enabled, as represented by the action 610 to share their personal data with brands, influencers, other retailers, or other types of business entities or categories of businesses entities via the consumer application 140. A wallet linked to the consumer application 140 of the end user 220 is topped up (i.e., value is added thereto) with a reward from the retailer vendor system 250D in stablecoin via the blockchain 260 based on terms of the smart contract 602. The end user 220 thereafter can receive electronic content from the retailer vendor system 250D and other selected and followed business entities, the electronic content including for example music, video, polls, challenges, and discounts and offers, which discounts and offers can be time relevant and location specific.

A business entity (e.g., a “brand” business entity) operating the brand vendor system 250E initiates actions described in brand actions 612 which includes actions recordable through the smart contract 602 via the blockchain 260. The brand vendor system 250E creates a business profile via the vendor application 251 and the system API server 230 and is assigned a unique identifier (“ID”). The brand vendor system 250E receives inquiry from the end user 220 to follow the brand and receives the permission of the end user 220 to share the personal data with the brand vendor system 250E via the vendor application 251 and the consumer application 140. The brand vendor system 250E accepts the inquiry and shares the cost of the reward provided by the retailer vendor system 250D with other business entities via other vendor systems 250 which the end user 220 has selected to follow, value in stablecoin is automatically transferred from a wallet linked to the vendor application 251 of the brand vendor system 250E to the wallet linked to the vendor application 251 of the retailer vendor system 250D. For example, if the end user 220 has selected to follow four (4) business entities, the transferred value from each business entity wallet can be divided four ways to achieve the total initial reward value from the retailer vendor system 250D or other business entity vendor system which funded the initial reward to the end user 220.

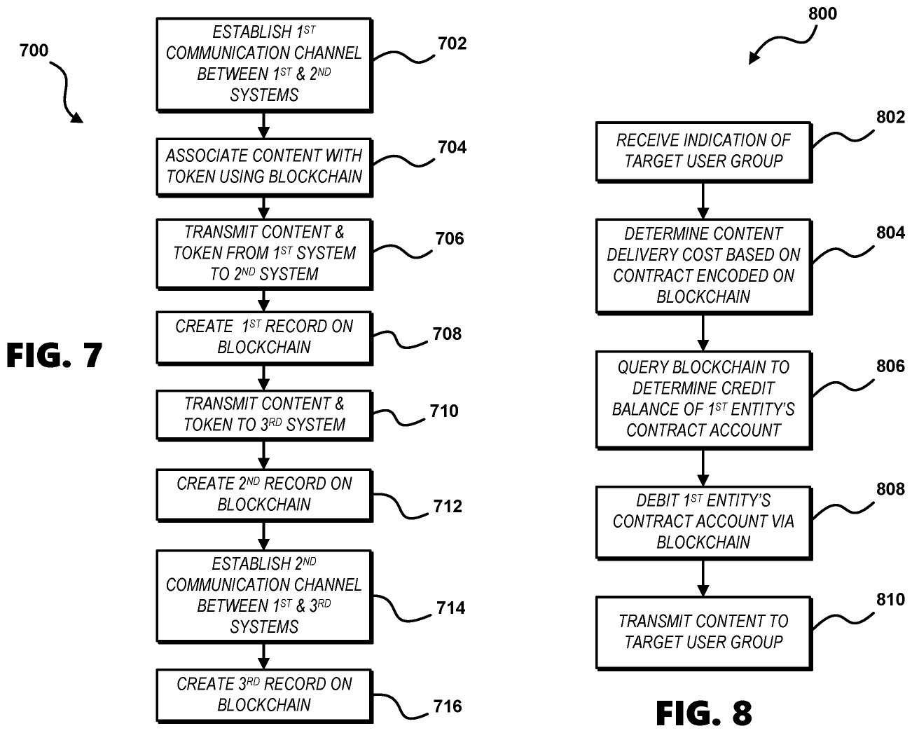

Referring to FIG. 7, a flowchart shows a method 700 of establishing communication channels for network-connectable devices. The method 700 and associated processes are can be performed via the components of the architecture 200 shown in FIG. 2, including the vendor system 250, system API server 230, consumer application 140, blockchain 260, and related components. Alternatively, the method 700 can be performed via other suitable systems.

In a step 702, a first communication channel is established between a first computing system and a second computing system within a computer network. Electronic content is associated with a token generated using a blockchain (step 704). The electronic content and the token is transmitted from the first computing system to the second computing system (step 706), and a first record is created on the blockchain, the first record corresponding to the transmitting of the electronic content and the token from the first computing system to the second computing system (step 708). The electronic content and the token are transmitted to a third computing system (step 710), and a second record is created on the blockchain corresponding to the transmitting of the electronic content and the token to the third computing system responsive to an instruction generated via the second computing system (step 712). A second communication channel is established between the first computing system and the third computing system (step 714), and a third record is created on the blockchain responsive to a user action via the third computing system (step 716).

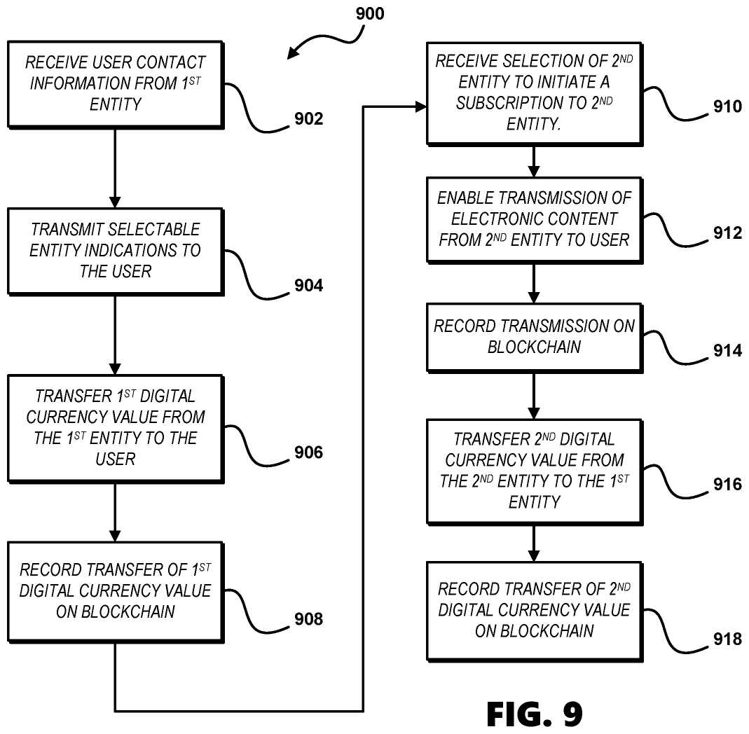

Referring to FIG. 8, a flowchart shows an electronic content delivering method 800. The method 800 and associated processes can be performed via the components of the architecture 200 shown in FIG. 2, including the vendor system 250, system API server 230, consumer application 140, blockchain 260, and related components. Alternatively, the method 800 can be performed via other suitable systems.

In a step 802, an indication of a targeted group of users to whom electronic content is to be delivered is received from a first entity (e.g., a business entity). A cost of delivering the electronic content to the group of users is determined based on a contract encoded on a blockchain (step 804). A credit balance of an electronic contract account of the first entity is determined by query to the blockchain (step 806). The electronic contract account of the first entity is debited via the blockchain based on the cost of delivering the electronic content to the group of users (step 808), and the electronic content is transmitted to the group of users (step 810).

Referring to FIG. 9, a flowchart shows an electronic content delivering method 900. The method 900 and associated processes can be performed via the components of the architecture 200 shown in FIG. 2, including the vendor system 250, system API server 230, consumer application 140, blockchain 260, and related components. Alternatively, the method 900 can be performed via other suitable systems.

In a step 902, contact information of a user is received from a first entity (e.g., a business entity). Selectable entity indications (e.g., business entity names) are transmitted to the user (e.g., via an application executed on a computing device) based on the contact information (step 904). A first digital currency value is transferred from the first entity to the user (step 906), and the transfer of value is recorded on a blockchain (step 908). A selection of a second entity (e.g., another business entity) is received from the user via the selectable entity indications (e.g., indications listed in a user interface of the computing device of the user) to initiate a subscription to the second entity (step 910). A transmission of electronic content from the second entity to the user is enabled (step 912), and the transmission of the electronic content from the second entity to the user is recorded on the blockchain (step 914). A second digital currency value from the second entity to the first entity is transferred responsive at least to the receiving from the user the selection of the second entity (step 916), and the transfer of the second digital currency value from the second entity to the first entity is recorded on the blockchain (step 918).

Although features and elements are described above in particular combinations, one of ordinary skill in the art will appreciate that each feature or element can be used alone or in any combination with the other features and elements. Methods described herein may be implemented in a computer program, software, or firmware incorporated in a computer-readable medium for execution by a computer or processor.

While embodiments have been described in detail above, these embodiments are non-limiting and should be considered as merely exemplary. Modifications and extensions may be developed, and all such modifications are deemed to be within the scope defined by the appended claims.

What is claimed is:

1. A network communication channel enabling method comprising:
establishing a first communication channel between a first computing system and a second computing system;
associating electronic content with a token generated using a blockchain;
transmitting the electronic content and the token from the first computing system to the second computing system and creating a first record on the blockchain corresponding to the transmitting of the electronic content and the token from the first computing system to the second computing system;
transmitting the electronic content and the token to a third computing system and creating a second record on the blockchain corresponding to the transmitting of the electronic content and the token to the third computing system responsive to an instruction generated via the second computing system; and
establishing a second communication channel between the first computing system and the third computing system and creating a third record on the blockchain responsive to a user action via the third computing system.

2. The method of claim 1, further comprising transmitting a response to the electronic content via the second communication channel from the third computing system to the first computing system responsive to the user action.

3. The method of claim 1, wherein the electronic content comprises an offer, the method further comprising:
establishing the second communication channel between the first computing system and the third computing system and creating the third record on the blockchain responsive to an acceptance of the offer via the third computing system; and
transmitting the acceptance of the offer via the second communication channel.

4. The method of claim 1, further comprising establishing the first communication channel responsive to a user selection of a vendor via an application executed by the first computing system.

5. An electronic content delivering method comprising:
receiving from a first entity an indication of a targeted group of users to whom electronic content is to be delivered;
determining a cost of delivering the electronic content to the group of users based on a contract encoded on a blockchain;
determining by query to the blockchain a credit balance of an electronic contract account of the first entity;
debiting via the blockchain the electronic contract account of the first entity based on the cost of delivering the electronic content to the group of users; and
transmitting the electronic content to the group of users.

6. The method of claim 5, wherein the targeted group of users are subscribers to electronic content of a second entity, the method further comprising:
determining a commission allocable to the second entity based on the contract encoded on the blockchain; and
debiting via the blockchain the electronic contract account of the first entity based on the commission allocable to the second entity.

7. A method for enabling secure transmitting of electronic content in a network, the method comprising:
receiving from a first entity contact information of a user;
transmitting to the user selectable entity indications via a computing device of the user based on the contact information;
transferring a first digital currency value from the first entity to the user via the computing device and recording the transferring of the first digital currency value on a blockchain;
receiving from the user via the computing device a selection of a second entity via the selectable entity indications to initiate a subscription to the second entity;
enabling a transmission of electronic content from the second entity to the user via the computing device and recording on the blockchain the transmission of the electronic content from the second entity to the user; and
transferring a second digital currency value from the second entity to the first entity responsive at least to the receiving from the user the selection of the second entity and recording on the blockchain the transferring of the second digital currency value from the second entity to the first entity.

8. The method of claim 7, further comprising:
receiving from the user via the computing device a selection of a third entity via the selectable entity indications to initiate a subscription to the third entity;
enabling a transmission of electronic content from the third entity to the user via the computing device and recording on the blockchain the transmission of the electronic content from the third entity to the user; and
transferring a third digital currency value from the third entity to the first entity responsive at least to the receiving from the user the selection of the third entity and recording on the blockchain the transferring of the third digital currency value from the third entity to the first entity.

9. The method claim 8, wherein the second digital currency value plus the third digital currency value is less than or equal to the first digital currency value.

10. The method of claim 7, wherein the electronic content comprises at least one of audio content, video content, a challenge game, or a discount coupon.

11. The method of claim 7, wherein at least one of the first digital currency value or the second digital currency value comprises a fungible currency.

12. The method of claim 7, wherein at least one of the first digital currency value or the second digital currency value comprises a fungible or non-fungible reward token.

13. The method of claim 7, wherein the transferring of the first digital currency value from the first entity to the user and the transferring of the second digital currency value from the second entity to the first entity are controlled by a contract encoded on the blockchain.
